(19) United States
(12) Patent Application Publication
(10) Pub. No.: US 2002/0176566 A1
(43) Pub. Date: Nov. 28, 2002

(54) Voice-controlled television set and operating method thereof

(76) Inventors: Woo-Jin Song, Seoul (KR); Won-Chul Song, Seoul (KR)

Correspondence Address: VOLENTINE FRANCOS, P.L.L.C., Suite 150, 12200 Sunrise Valley Drive, Reston, VA, 20191, US

(21) Appl. No.: 10/206,766

(22) Filed: Jul. 29, 2002

Related U.S. Application Data
(63) Continuation of application No. PCT/KR01/02240, filed on Dec. 21, 2001.

(30) Foreign Application Priority Data
Dec. 29, 2000 (KR) 2000-0084950

(51) Int. Cl. H04M 1/00; H04M 1/76

(52) U.S. Cl. 379/388.01; 379/416; 379/392.01

(57) ABSTRACT

A device and method of eliminating the interference to a voice command from the sound from the speaker, thereby improving the success rate of speech recognition even in the presence of the direct and echoed sound.

The present invention comprises a device producing an estimated signal representing the interfering sound at a microphone, and acquiring an interference-free signal by subtracting the estimated interfering signal from the interfered signal while minimizing an error signal.

### CROSS-REFERENCES TO RELATED APPLICATIONS

This application is a continuation of International Patent Application PCT/KR01/02240 filed on Dec. 21, 2001, claiming the priority benefit from Korean Patent Application 2000-0084950, filed on Dec. 29, 2000, the entirety of each of which is hereby incorporated by reference for all purposes as if fully set for the herein.

### TECHNICAL FIELD

The present invention is related to a voice-controlled television set and operating method thereof, and more particularly to a technique of eliminating the interference between the voice command signal and the direct and echoed sound from the television speaker.

### BACKGROUND

Recently, a great deal of research work has been focused on the development of a means to simplify the interface between the user and the machine.

The wireless remote control unit is currently the most commonly used tool for implementing a television set and human interface. However, a simpler and more natural interface between a human being and the television set would be human speech.

A voice-recognition television set recognizes the human speech command for the control of various functions, e.g., power on/off, channel switching, and volume control, screen adjustment, etc. The related art is disclosed in the U.S. Pat. No. 6,119,088 and Japanese Patent No. 5,289,690.

The prior art, however, has a limit for a practical use as a voice-recognition device because of the interference problem at a microphone between the voice command and the background sound originated from the reflected sound wave in the room, as well as the sound directly from the speaker.

As a consequence of the above-mentioned strong interference between the voice command and the sound from the sound speaker, the voice-recognition rate of the voice commands tends to be poor.

### BRIEF SUMMARY

The present invention is directed to a voice-recognition device and method for a successful recognition of voice commands even in the presence of the direct and echoed (reflected) sound from the sound speaker.

In accordance with an embodiment of the present invention, a method and device are provided for eliminating the interference for the clear recognition of speech commands at a microphone.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 is a schematic diagram illustrating an embodiment of a voice-recognition television set having an internal or an external microphone.

FIG. 2 is a schematic diagram illustrating a functional block for eliminating interference between a voice command and the direct and echoed sound from the speaker.

FIG. 3 is a schematic block diagram of a device for eliminating interference at the microphone.

FIG. 4 is a schematic diagram illustrating an embodiment of an adaptive digital tapped-delay line filter with varying weighting coefficient.

FIG. 5 is a schematic diagram illustrating an embodiment of a coefficient generator for an adaptive digital tapped-delay line filter.

### DETAILED DESCRIPTION

The present invention will now be described more fully hereinafter with reference to the accompanying drawings, in which preferred embodiments of the invention are shown.

This invention may, however, be embodied in different forms and should not be construed as limited to the embodiments set forth herein.

Rather, these embodiments are provided so that this disclosure will be thorough and complete, and will fully convey the scope of the invention to those skilled in the art.

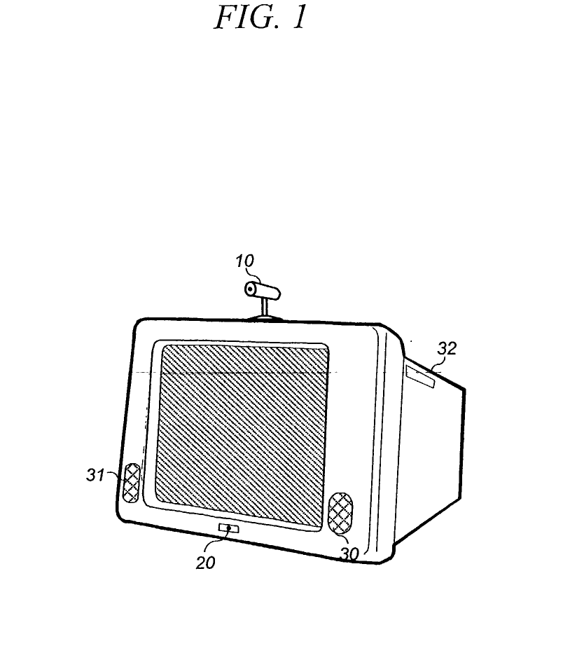

FIG. 1 is a schematic diagram illustrating an embodiment of a voice-recognition television set having an internal or an external microphone.

Referring to FIG. 1, either the external microphone 10 or the internal microphone 20 can be installed for receiving the voice command, i.e. power on/off command, channel switching command, screen adjustment command, and volume control command.

In particular, the sound directly from the right 30 and left 31 speakers as well as the echoed sound in the room is added to the voice command and then applied to the microphones 10 and 20.

In this case, the present invention has a feature in that the television set 32 includes a device for extracting the voice command from the interfering sound.

Let Z(t) represent the total sound signal received by the microphone 50. Then Z(t) is the sum of the voice command sound signal and x(t), the interference sound signal produced by the speaker.

The interference sound signals at the microphones 10, 20 can be considered to be the sum of the sound from the speaker and the echoed sound that has experienced attenuation, delay, and phase change.

Let s(t) be the sound directly from the speaker, then the interference signal x(t) at the microphone can be described as follows.

x(t)=Ò₁s(t−t₁)+Ò₂s(t−t₂)+Ò₃s(t−t₃)+ . . . (1)

Here, Ò₁, Ò₂, Ò₃, . . . represent the attenuation and phase change according to the propagation path, and t₁, t₂, t₃, . . . represent delay time.

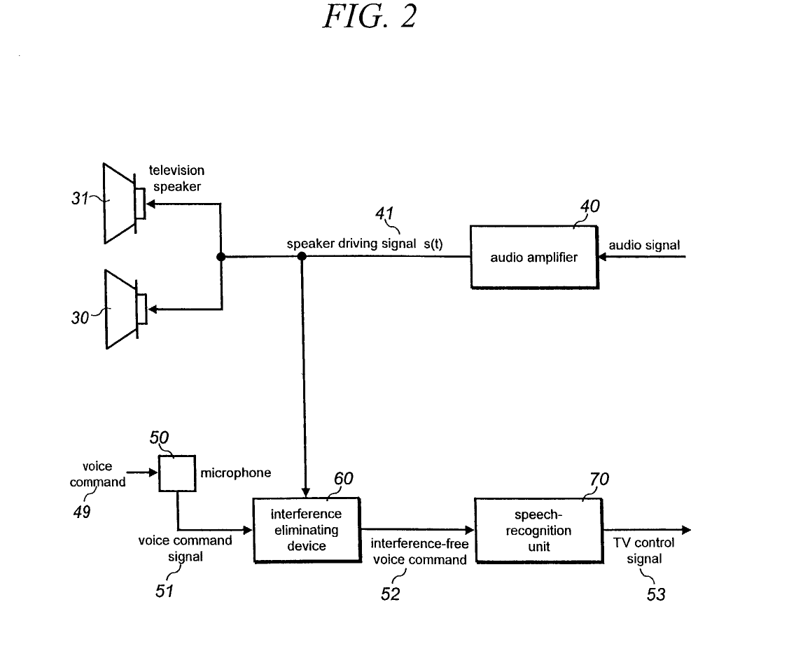

FIG. 2 is a schematic diagram illustrating a functional block for eliminating the interference between the voice command and the direct and echoed sound from the speaker.

Referring to FIG. 2, an interference-eliminating device 60 in accordance with the present invention extracts the signal s(t), which drives the speaker 31 and 32, and then accurately estimates the interference signal x(t).

Thereafter, the estimated interference signal x(t) is subtracted from the total sound signal Z(t) at the microphone.

Since the signal 51 of the voice command from the user has nothing to do with the speaker driving signal s(t) 41, the electric signal passing through the interference-eliminating device 60 in accordance with the present invention remains free from interference even with the voice command applied.

As a consequence, the success rate of the voice-recognition will increase because the interference-free voice command is forwarded to the voice-recognition device 70.

The voice-recognition device 70 can be implemented by software in a microprocessor as well as hardware. Finally, the interference-free voice command is then transformed into appropriate data for the TV control via the voice-recognition device 70.

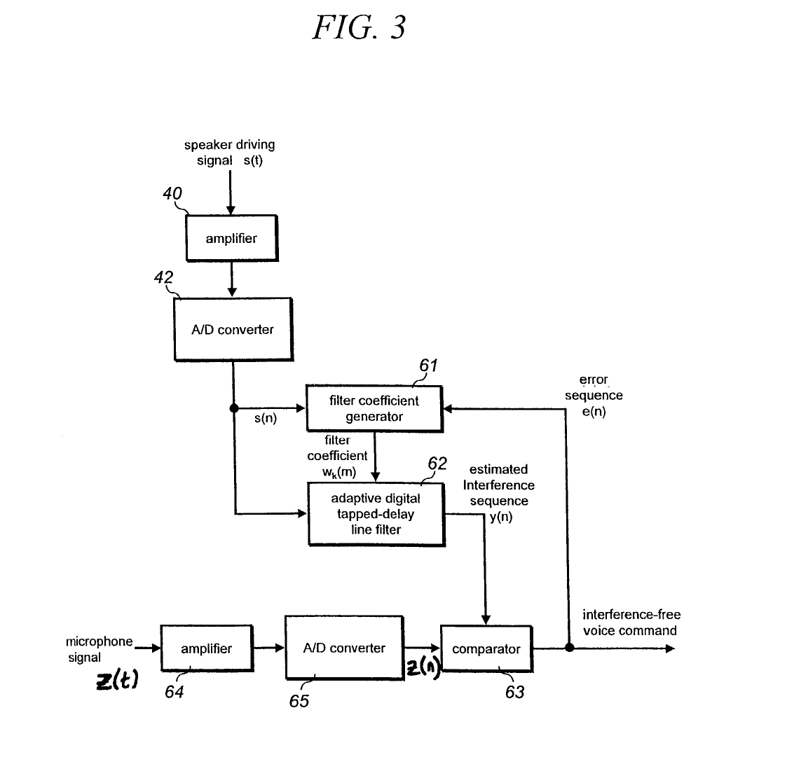

FIG. 3 is a schematic diagram of a device for eliminating the interference at a microphone.

Referring to FIG. 3, the amplitude of the speaker driving signal s(t) is appropriately adjusted for the application to the following analog-to-digital (A/D) converter 42.

The A/D converter 42 samples the signal s(t) and the sampled signal is thereafter quantized as s[n].

Here, n represents the n-th sampled digital value. Finally, an adaptive digital tapped-delay line filter 62 estimates the interference sequence y[n] from the digital sequence s[n].

y[n]=w₀s[n]+w₁s[n−1]+ . . . +w_{N-1}s[n−(N−1)] (2)

Here, w₀, w₁, . . . w_{N-1} represent the coefficients of the filter 62. The N coefficients of the adaptive digital tapped-delay line filter 62 are to be adjusted in such a manner that y[n] should be the estimated sequence due to the interference with the speaker sound.

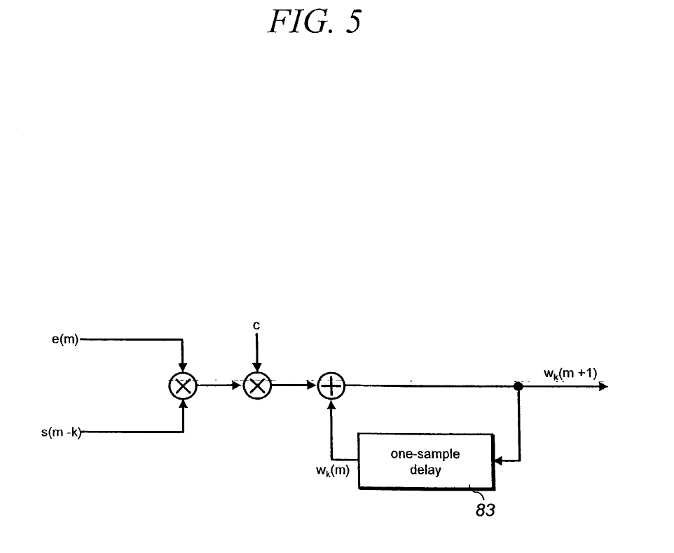

In the meanwhile, the N coefficients (w₁, w₂, . . . , w_{N-1}) of the filter 62 for y[n] can be produced at a coefficient generator 61 for the filter 62, which will be explained in detail with FIG. 5.

Beneficially, the adaptive digital tapped-delay line filter 62 can be implemented either with a digital arithmetic circuit comprising multipliers and adders or with a microprocessor program.

Now, the signal Z(t) from the microphone is applied at the input of an amplifier 64 for the adjustment of the signal strength, followed by the sampling and quantizing steps to produce a digital sequence of Z[n].

Since the interference signal x(t) has been superimposed by the attenuated, delayed, and phase-changed signal, which originates from the speaker driving signal s(t), the interference-free sequence can be obtained by subtracting the estimated interference sequence y[n] from the digital sequence Z[n].

Consequently, it is possible to have an interference-free voice signal at the input stage of voice command.

The interference-free sequence e[n], which has been obtained by subtracting y[n] from Z[n], is then applied to the voice-recognition unit 70 as well as the coefficient generator 61 for the filter 62.

As a consequence, a set of the coefficients w₀, w₁, . . . , w_{N-1} for the filter 62 are re-adjusted and iterated in such a manner that the estimated sequence y[n] is more close to the interfered sound.

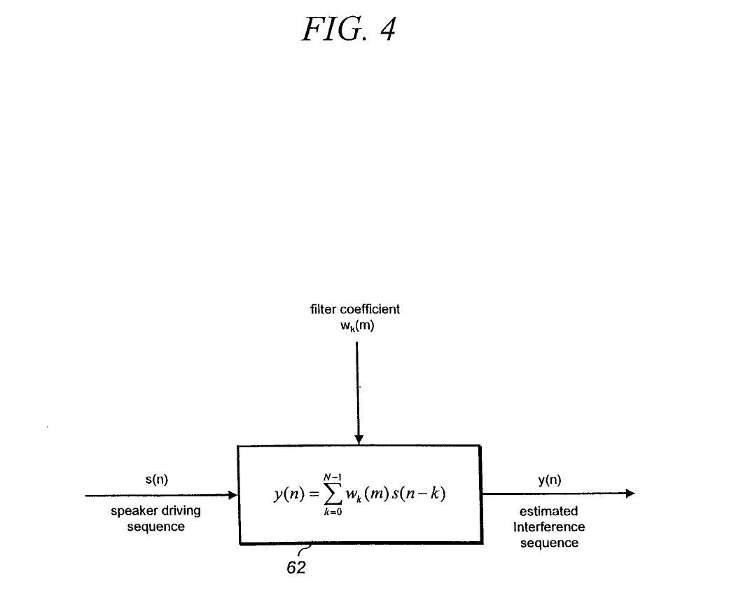

FIG. 4 is a schematic diagram illustrating the functional block of an embodiment of the adaptive digital tapped-delay line filter.

Referring to FIG. 4, the adaptive digital tapped-delay filter 62 is implemented with multipliers and adders to produce y[n] in terms of the speaker driving sequence s[n] with the filter coefficients wₖ[n] (k=0, 1, . . . , N−1).

FIG. 5 is a schematic diagram illustrating an embodiment of a coefficient generator for the adaptive digital tapped-delay line filter.

Referring to FIG. 5, the coefficients of the filter are adjusted by minimizing the squared value of the error e[n] between x[n] and y[n].

As a preferred embodiment for the error minimization, either the least mean square (LMS) method or the recursive least square (RLS) method can be employed.

More preferably, the LMS method can be employed. A set of new coefficients (w₀[m+1], w₁[m+1], . . . , w_{N-1}[m+1]) at time step (m+1) can be calculated from the old set of the coefficients (w₀[m], w₁[m], . . . , w_{N-}1[m]) at a previous time step m. In this case, the set of s[m], s[m−1], . . . , s[m−(N−1)] and the error e[m] are also employed for the calculation of a new set.

wₖ[m+1]=wₖ[m]+ce[m]s[m−k] (3)

Here k=0, 1, 2, . . . , N−1, and c is a parameter controlling the increment for the update of the coefficients. In the meanwhile, the initial values of the filter coefficients can be set to be zero.

The updated coefficients are then applied to the adaptive digital tapped-delay filter 62 to produce a better output y[m+1].

By iterating the above-mentioned procedure for producing the estimated signal of the interference, the magnitude of the absolute value of e[n] becomes smaller and smaller, i.e., stabilized.

Finally, the error difference between the portion of the digital sequence Z[n] representing the real interference and the estimated sequence y[n] becomes trivial and ultimately e[n] becomes the interference-free sequence of the speech command.

Now, the digital sequence of the interference-free voice command is then applied to the voice-recognition unit 70 and translated into a data for the TV control.

Beneficially, the interference-eliminating device can be implemented either with hardware or with programmed software in a microprocessor.

Once the speech is recognized, the central processing unit in the television set performs the control of power on/off, channel switching, and volume control, etc. in accordance with the voice command.

Although the invention has been illustrated and described with respect to exemplary embodiments thereof, it should be understood by those skilled in the art that various other changes, omissions and additions may be made therein and thereto, without departing from the spirit and scope of the invention.

Therefore, the present invention should not be understood as limited to the specific embodiment set forth about but to include all possible embodiments which can be embodies within a scope encompassed and equivalents thereof with respect to the feature set forth in the appended claims.

What is claimed is:

1. A device eliminating interference to a voice command from sound from a speaker, comprising:
a first A/D converter producing a digital sequence s[n] by sampling and quantizing a signal driving the speaker;
an adaptive digital tapped-delay filter producing an estimated sequence
y[n]=w₀s[n]+w₁s[n−1]+w₂s[n−2]+ . . . +w_{N-1}s[n−(N−1)]
from said digital sequence s[n] with a set of filter coefficients w₀, w₁, . . . , w_{N-1};
a second A/D converter producing a digital sequence Z[n] by sampling and quantizing a voice command signal superimposed with direct and echoed sound from the speaker;
a comparator producing an error sequence e[n] that is a difference between Z[n] and y[n]; and
a filter coefficient generator producing a set of filter coefficients
w₀[m+1], w₁[m+1], . . . , w_{N-1}[m+1] at time step (m+1) from a set of filter coefficients wₒ[m], w₁[m], . . . , w_{N-1}[m] at time step m, s[m], and e[m] to minimize either the magnitude or the power of the error sequence e[n].

2. The device as set forth in claim 1 wherein said filter coefficient generator minimizes the error sequence e[n] by a least mean square (LMS) method.

3. The device as set forth in claim 1 wherein said filter coefficient generator minimizes the error sequence e[n] by a recursive least square (RLS) method.

4. The device as set forth in claim 1 wherein said filter coefficient generator produces a set of next-step filter coefficients
wₖ[m+1]=wₖ[m]+ce[m]s[m−k],
k=0, 1, . . . , N−1, from a set of previous step filter coefficients wₖ[m], where c is a fixed number, and the initial filter coefficients at m=0 are all set to be zero.

5. The device as set forth in claim 1 wherein said adaptive digital tapped-delay filter is implemented either by an arithmetic unit comprising a plurality of multipliers and an adder, or by a programmed microprocessor.

6. The device as set forth in claim 1 wherein said filter coefficient generator is implemented either by an arithmetic unit comprising a plurality of multipliers and an adder or by a programmed microprocessor.

7. The device as set forth in claim 1 wherein said voice command includes either one or a combination of the group comprising a power on/off command, channel switching command, volume control command, and screen adjustment command.

8. The device as set forth in claim 1 wherein said second A/D converter further comprises an amplifier adjusting the amplitude of the voice command signal.

9. The device as set forth in claim 1 wherein said voice command signal is received by a microphone installed internally or externally to a television set, or on a remote control unit.

10. A method eliminating interference to a voice command from sound from the speaker, comprising:
(a) converting a speaker-driving signal into a digital sequence s[n] by sampling and quantizing said speaker driving signal;
(b) producing a digital sequence Z[n] by sampling and quantizing a voice command signal superimposed with direct and echoed sound from the speaker;
(c) producing an estimated sequence y[n], from an equation of
y[n]=w₀s[n]+w₁s[n−1]+ . . . +w_{N-1}s[n−(N−1)],
with N filter coefficients w₀, w₁, . . . , w_{N-1};
(d) producing a difference sequence, e[n], by comparing the estimated sequence y[n] and the sequence Z[n];
(e) generating a set of new filter coefficients w₀[m+1], w₁[m+1], . . . , w_{N-1}[m+1] at time step (m+1) from a set of old filter coefficients w₀[m], w₁[m], . . . , w_{N-1}[m] at time step m, and s[n]; and
(f) iterating said steps of (d) until at least one of a magnitude and a power of said e[n] is minimized.

11. The method as set forth in claim 10 wherein said step (e) comprises generating a set of filter coefficients wₖ[m+1] at step (m+1) from an equation of
wₖ[m+1]=wₖ[m]+ce[m]s[m−k],
k=0, 1, . . . , N−1.
